(19) United States
(12) Patent Application Publication
(10) Pub. No.: US 2009/0279458 A1
(43) Pub. Date: Nov. 12, 2009

(54) Uplink and Downlink Hybrid Automatic Repeat Request In Time Division Multiplex Communications

(75) Inventors: Zukang Shen, Allen, TX (US); Tarik Muharemovic, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/409,691

(22) Filed: Mar. 24, 2009

Related U.S. Application Data
(60) Provisional application No. 61/038,899, filed on Mar. 24, 2008.

(51) Int. Cl. H04J 3/00; H04W 4/00

(52) U.S. Cl. 370/280; 370/329

(57) ABSTRACT

This invention notes various patterns of uplink and downlink communication in a wireless communication system which satisfy the requirement that a user equipment receiving a downlink grant in subframe n needs to transmit response ACK/NAK bits in an uplink subframe n+k, where k>3 and a user equipment receiving a DL grant or ACK/NAK on physical hybrid automatic repeat request channel (PHICH) in subframe n needs to transmit or retransit UL data bits in an uplink (UL) subframe n+k, where k>3.

### CLAIM OF PRIORITY

This application claims priority under 35 U.S.C. 119(e)(1) to U.S. Provisional Application No. 61/038,899 filed Mar. 24, 2008.

### TECHNICAL FIELD OF THE INVENTION

The technical field of this invention is wireless communication.

### BACKGROUND OF THE INVENTION

FIG. 1 shows an exemplary wireless telecommunications network 100. The illustrative telecommunications network includes base stations 101, 102 and 103, though in operation, a telecommunications network necessarily includes many more base stations. Each of base stations 101, 102 and 103 are operable over corresponding coverage areas 104, 105 and 106. Each base station's coverage area is further divided into cells. In the illustrated network, each base station's coverage area is divided into three cells. Handset or other user equipment (UE) 109 is shown in Cell A 108. Cell A 108 is within coverage area 104 of base station 101. Base station 101 transmits to and receives transmissions from UE 109. As UE 109 moves out of Cell A 108 and into Cell B 107, UE 109 may be handed over to base station 102. Because UE 109 is synchronized with base station 101, UE 109 can employ non-synchronized random access to initiate handover to base station 102.

Non-synchronized UE 109 also employs non-synchronous random access to request allocation of up-link 111 time or frequency or code resources. If UE 109 has data ready for transmission, which may be traffic data, measurements report, tracking area update, UE 109 can transmit a random access signal on up-link 111. The random access signal notifies base station 101 that UE 109 requires up-link resources to transmit the UE's data. Base station 101 responds by transmitting to UE 109 via down-link 110, a message containing the parameters of the resources allocated for UE 109 up-link transmission along with a possible timing error correction. After receiving the resource allocation and a possible timing advance message transmitted on down-link 110 by base station 101, UE 109 optionally adjusts its transmit timing and transmits the data on up-link 111 employing the allotted resources during the prescribed time interval.

FIG. 2 shows the Evolved Universal Terrestrial Radio Access (E-UTRA) time division duplex (TDD) Frame Structure. Different subframes are allocated for downlink (DL) or uplink (UL) transmissions. Table 1 shows applicable DL/UL subframe allocations.

TABLE 1

| | Switch- | | | | | | | | | | |
|---|---|---|---|---|---|---|---|---|---|---|---|
| Con- | point | Subframe number | | | | | | | | | |
| figuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 10 ms | D | S | U | U | U | D | S | U | U | D |

One interesting property of TDD is that the number of UL and DL subframes can be different. In the configurations where there are more DL subframes than UL subframes, multiple DL subframes are associated with one single UL subframe for transmission of corresponding control signal. For example, for each dynamically scheduled transmission in the DL subframes, acknowledge and non-acknowledge (ACK/NAK) bits need to be transmitted in an associated UL subframe to support proper hybrid automatic repeat request (HARQ) operation. If UE 109 is scheduled in a multiple of DL subframes all of which are associated with one single UL subframe, UE 109 needs to transmit multiple ACK/NAK bits in that single UL subframe.

### SUMMARY OF THE INVENTION

This invention notes various patterns of uplink and downlink communication in a wireless communication system which satisfy the requirement that a user equipment receiving a downlink grant in subframe n needs to transmit response ACK/NAK bits in an uplink subframe n+k, where k>3 and a user equipment receiving a DL grant or ACK/NAK on physical hybrid automatic repeat request channel (PHICH) in subframe n needs to transmit or retransmit UL data bits in an uplink (UL) subframe n+k, where k>3.

### BRIEF DESCRIPTION OF THE DRAWINGS

These and other aspects of this invention are illustrated in the drawings, in which:

FIG. 1 is a diagram of a communication system of the prior art related to this invention having three cells;

FIG. 2 shows the Evolved Universal Terrestrial Radio Access (E-UTRA) TDD Frame Structure of the prior art;

FIG. 3 illustrates the ACK/NAK response paths for a downlink/uplink subframe configuration 0;

FIG. 4 illustrates the ACK/NAK response paths for a downlink/uplink subframe configuration 1;

FIG. 5 illustrates the ACK/NAK response paths for a downlink/uplink subframe configuration 2;

FIG. 6 illustrates the ACK/NAK response paths for a downlink/uplink subframe configuration 3;

FIG. 7 illustrates a first alternative of ACK/NAK response paths for a downlink/uplink subframe configuration 3;

FIG. 8 illustrates a second alternative of ACK/NAK response paths for a downlink/uplink subframe configuration 3;

FIG. 9 illustrates the ACK/NAK response paths for a downlink/uplink subframe configuration 4;

FIG. 10 illustrates the ACK/NAK response paths for a downlink/uplink subframe configuration 5;

FIG. 11 illustrates the ACK/NAK response paths for a downlink/uplink subframe configuration 6;

FIG. 12 illustrates the UL data response paths for a DL/UL subframe configuration 0;

FIG. 13 illustrates an alternate UL data response paths for a DL/UL subframe configuration 0;

FIG. 14 illustrates the UL data response paths for a DL/UL subframe configuration 1;

FIG. 15 illustrates the UL data response paths for a DL/UL subframe configuration 2;

FIG. 16 illustrates the UL data response paths for a DL/UL subframe configuration 3;

FIG. 17 illustrates the UL data response paths for a DL/UL subframe configuration 4;

FIG. 18 illustrates the UL data response paths for a DL/UL subframe configuration 5; and

FIG. 19 illustrates the UL data response paths for a DL/UL subframe configuration 6.

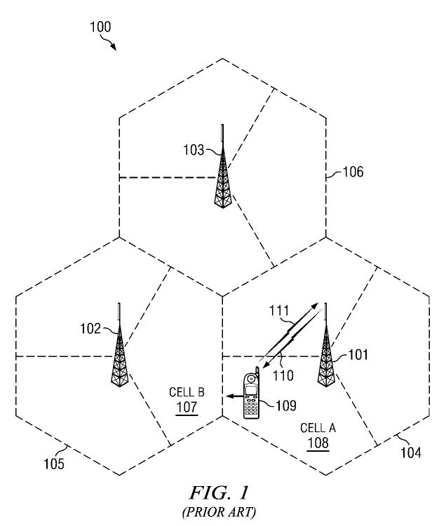

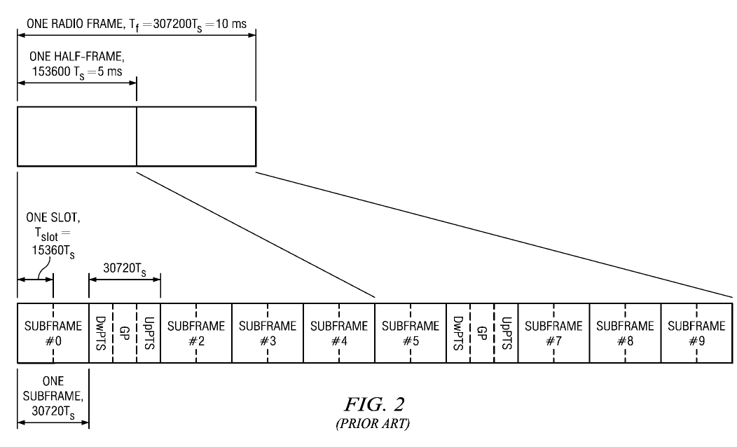

### DETAILED DESCRIPTION OF PREFERRED EMBODIMENTS

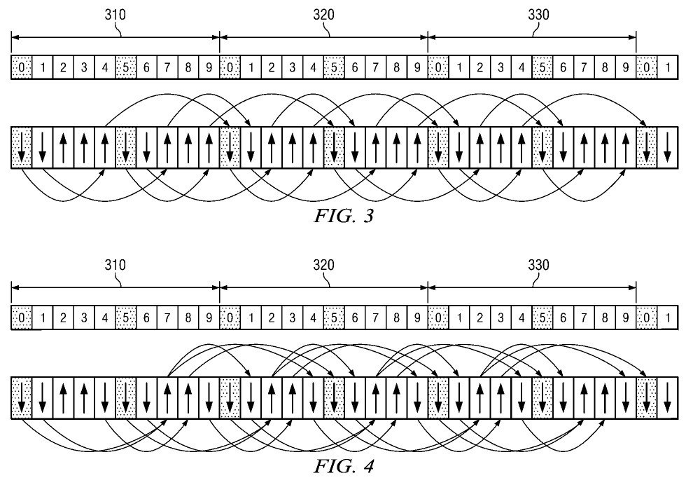

The 3GPP TS 36.211 standard requires in time division duplex (TDD) downlink (DL) that a UE 109 receiving a DL grant in subframe n needs to transmit response ACK/NAK bits in an uplink (UL) subframe n+k, where k>3. FIGS. 3 to 11 illustrate the relation between DL/UL subframes associations for various combinations of assignments of DL/UL to particular subframes. Each of theses relations illustrated in FIGS. 3 to 11 are compliant with the requirement of the standard. FIGS. 3 to 11 illustrate frames 310, 320 and 330. Each frame 310, 320 and 330 has subframes 0 to 9. Subframes 0 and 5 are shaded to aid in determining the subframe alignment in the drawings.

FIG. 3 illustrates the ACK/NAK response paths for a DL/UL subframe configuration 0 where subframes 0, 1, 5 and 6 are devoted to DL and subframes 2, 3, 4, 7, 8 and 9 are devoted to UL. A UE 109 receiving a DL grant in subframe 0 transmits a responsive ACK/NAK signal in subframe 4. A UE 109 receiving a DL grant in subframe 1 transmits a responsive ACK/NAK signal in subframe 7. A UE 109 receiving a DL grant in subframe 5 transmits a responsive ACK/NAK signal in subframe 9. A UE 109 receiving a DL grant in subframe 6 transmits a responsive ACK/NAK signal in subframe 1 of the next frame. Each of the UL subframes 2, 4, 7 and 9 receive DL grant signals from a single DL subframe. UL subframes 3, 5 and 8 receive DL grant signals from no DL subframe.

FIG. 4 illustrates the ACK/NAK response paths for a DL/UL subframe configuration 1 where subframes 0, 1, 4, 5, 6 and 9 are devoted to DL and subframes 2, 3, 7 and 8 are devoted to UL. A UE 109 receiving a DL grant in subframe 0 transmits a responsive ACK/NAK signal in subframe 7. A UE 109 receiving a DL grant in subframe 1 also transmits a responsive ACK/NAK signal in subframe 7. A UE 109 receiving a DL grant in subframe 4 transmits a responsive ACK/NAK signal in subframe 8. A UE 109 receiving a DL grant in subframe 5 transmits a responsive ACK/NAK signal in subframe 2 of the next frame. A UE 109 receiving a DL grant in subframe 6 also transmits a responsive ACK/NAK signal in subframe 2 of the next frame. A UE 109 receiving a DL grant in subframe 9 transmits a responsive ACK/NAK signal in subframe 3 of the next frame. Each of the UL subframes 2 and 7 receive DL grant signals from two DL subframes. Each of UL subframes 3 and 8 receive DL grant signals from one DL subframe.

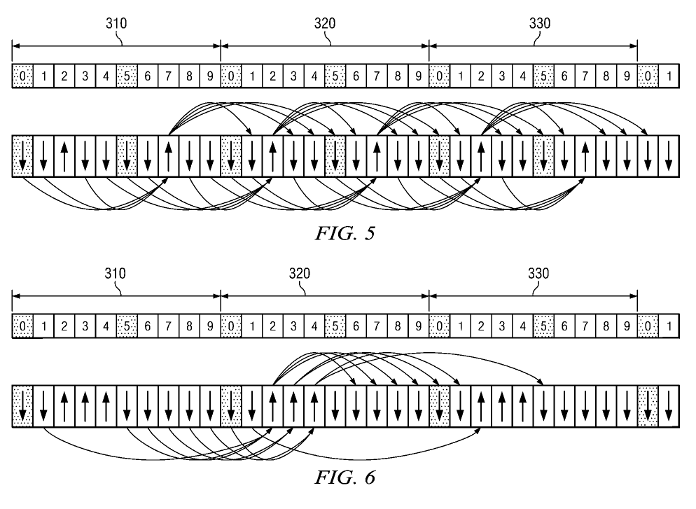

FIG. 5 illustrates the ACK/NAK response paths for a DL/UL subframe configuration 2 where subframes 0, 1, 3, 4, 5, 6, 8 and 9 are devoted to DL and subframes 2 and 7 are devoted to UL. A UE 109 receiving a DL grant in subframe 0 transmits a responsive ACK/NAK signal in subframe 7. A UE 109 receiving a DL grant in subframe 1 also transmits a responsive ACK/NAK signal in subframe 7. A UE 109 receiving a DL grant in subframe 3 also transmits a responsive ACK/NAK signal in subframe 7. A UE 109 receiving a DL grant in subframe 4 transmits a responsive ACK/NAK signal in subframe 2 of the next frame. A UE 109 receiving a DL grant in subframe 5 also transmits a responsive ACK/NAK signal in subframe 2 of the next frame. A UE 109 receiving a DL grant in subframe 6 also transmits a responsive ACK/NAK signal in subframe 2 of the next frame. A UE 109 receiving a DL grant in subframe 8 also transmits a responsive ACK/NAK signal in subframe 2 of the next frame. A UE 109 receiving a DL grant in subframe 9 transmits a responsive ACK/NAK signal in subframe 7 of the next frame. Each of the UL subframes 2 and 7 receive DL grant signals from four DL subframes.

FIG. 6 illustrates the ACK/NAK response paths for a DL/UL subframe configuration 3 where subframes 0, 1, 5, 6, 7, 8 and 9 are devoted to DL and subframes 2, 3 and 4 are devoted to UL. A UE 109 receiving a DL grant in subframe 0 transmits a responsive ACK/NAK signal in subframe 4. A UE 109 receiving a DL grant in subframe 1 transmits a responsive ACK/NAK signal in subframe 2 of the next frame. A UE 109 receiving a DL grant in subframe 5 also transmits a responsive ACK/NAK signal in subframe 2 of the next frame. A UE 109 receiving a DL grant in subframe 6 also transmits a responsive ACK/NAK signal in subframe 2 of the next frame. A UE 109 receiving a DL grant in subframe 7 transmits a responsive ACK/NAK signal in subframe 3 of the next frame. A UE 109 receiving a DL grant in subframe 8 also transmits a responsive ACK/NAK signal in subframe 3 of the next frame. A UE 109 receiving a DL grant in subframe 9 transmits a responsive ACK/NAK signal in subframe 3 of the next frame. UL subframe 2 receives DL grant signals from three DL subframes. Each of the UL subframes 3 and 4 receive DL grant signals from two DL subframes.

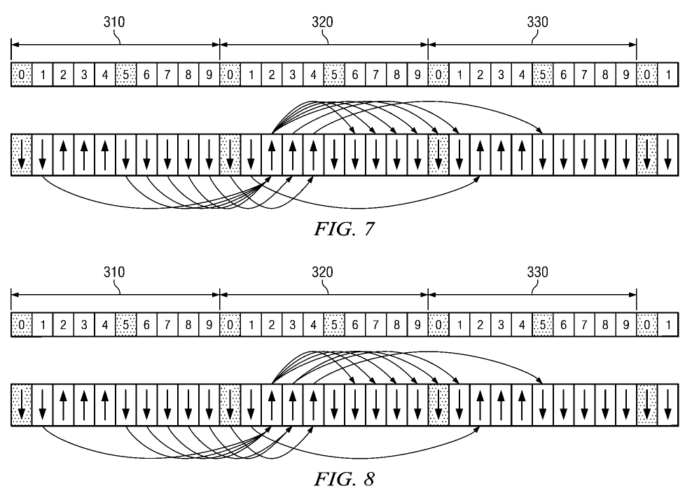

FIG. 7 illustrates a first alternate of the ACK/NAK response paths for a DL/UL subframe configuration 3 where subframes 0, 1, 5, 6, 7, 8 and 9 are devoted to DL and subframes 2, 3 and 4 are devoted to UL. A UE 109 receiving a DL grant in subframe 0 transmits a responsive ACK/NAK signal in subframe 4. A UE 109 receiving a DL grant in subframe 1 transmits a responsive ACK/NAK signal in subframe 2 of the next frame. A UE 109 receiving a DL grant in subframe 5 also transmits a responsive ACK/NAK signal in subframe 2 of the next frame. A UE 109 receiving a DL grant in subframe 6 also transmits a responsive ACK/NAK signal in subframe 2 of the next frame. A UE 109 receiving a DL grant in subframe 7 also transmits a responsive ACK/NAK signal in subframe 2 of the next frame. A UE 109 receiving a DL grant in subframe 8 transmits a responsive ACK/NAK signal in subframe 3 of the next frame. A UE 109 receiving a DL grant in subframe 9 transmits a responsive ACK/NAK signal in subframe 3 of the next frame. UL subframe 2 receives DL grant signals from five DL subframes. Each of the UL subframes 3 and 4 receive DL grant signals from one DL subframe.

FIG. 8 illustrates a second alternative of the ACK/NAK response paths for a DL/UL subframe configuration 3 where subframes 0, 1, 5, 6, 7, 8 and 9 are devoted to DL and subframes 2, 3 and 4 are devoted to UL. A UE 109 receiving a DL grant in subframe 0 transmits a responsive ACK/NAK signal in subframe 4. A UE 109 receiving a DL grant in subframe 1 transmits a responsive ACK/NAK signal in subframe 2 of the next frame. A UE 109 receiving a DL grant in subframe 5 also transmits a responsive ACK/NAK signal in subframe 2 of the next frame. A UE 109 receiving a DL grant in subframe 6 also transmits a responsive ACK/NAK signal in subframe 2 of the next frame. A UE 109 receiving a DL grant in subframe 7 also transmits a responsive ACK/NAK signal in subframe 2 of the next frame. A UE 109 receiving a DL grant in subframe 8 also transmits a responsive ACK/NAK signal in subframe 3 of the next frame. A UE 109 receiving a DL grant in subframe 9 also transmits a responsive ACK/NAK signal in subframe 3 of the next frame. UL subframe 2 receives DL grant signals from four DL subframes. UL subframe 3 receives DL grant signals from two DL subframes. UL subframe 4 receives DL grant signal form a single DL subframe.

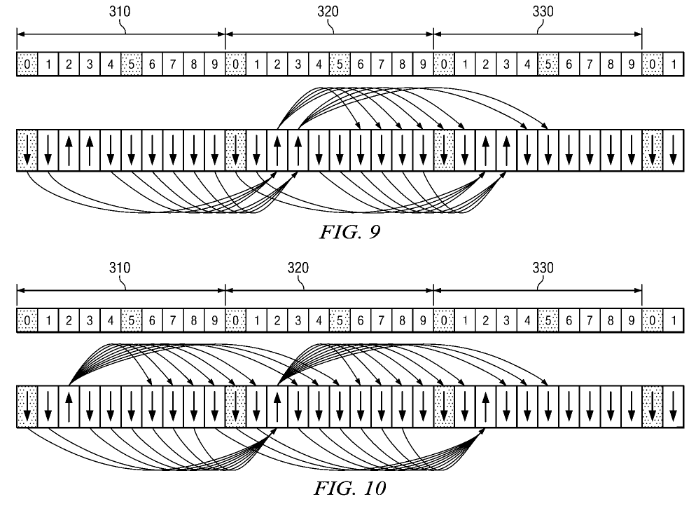

FIG. 9 illustrates the ACK/NAK response paths for a DL/UL subframe configuration 4 where subframes 0, 1, 4, 5, 6, 7, 8 and 9 are devoted to DL and subframes 2 and 3 are devoted to UL. A UE 109 receiving a DL grant in subframe 0 transmits a responsive ACK/NAK signal in subframe 2 of the next frame. A UE 109 receiving a DL grant in subframe 1 also transmits a responsive ACK/NAK signal in subframe 2 of the next frame. A UE 109 receiving a DL grant in subframe 4 also transmits a responsive ACK/NAK signal in subframe 2 of the next frame. A UE 109 receiving a DL grant in subframe 5 also transmits a responsive ACK/NAK signal in subframe 2 of the next frame. A UE 109 receiving a DL grant on subframe 6 transmits a responsive ACK/NAK signal on subframe 3 of the next frame. A UE 109 receiving a DL grant in subframe 7 also transmits a responsive ACK/NAK signal in subframe 3 of the next frame. A UE 109 receiving a DL grant in subframe 8 also transmits a responsive ACK/NAK signal in subframe 3 of the next frame. A UE 109 receiving a DL grant in subframe 9 also transmits a responsive ACK/NAK signal in subframe 3 of the next frame. Each of UL subframes 2 and 3 receives DL grant signals from four DL subframes.

FIG. 10 illustrates the ACK/NAK response paths for a DL/UL subframe configuration 5 where subframes 0, 1, 3, 4, 5, 6, 7, 8 and 9 are devoted to DL and subframe 2 is devoted to UL. A UE 109 receiving a DL grant in subframe 0 transmits a responsive ACK/NAK signal in subframe 2 of the next frame. A UE 109 receiving a DL grant in subframe 1 also transmits a responsive ACK/NAK signal in subframe 2 of the next frame. A UE 109 receiving a DL grant in subframe 4 also transmits a responsive ACK/NAK signal in subframe 2 of the next frame. A UE 109 receiving a DL grant in subframe 5 also transmits a responsive ACK/NAK signal in subframe 2 of the next frame. A UE 109 receiving a DL grant on subframe 6 also transmits a responsive ACK/NAK signal on subframe 2 of the next frame. A UE 109 receiving a DL grant in subframe 7 also transmits a responsive ACK/NAK signal in subframe 2 of the next frame. A UE 109 receiving a DL grant in subframe 8 also transmits a responsive ACK/NAK signal in subframe 2 of the next frame. A UE 109 receiving a DL grant in subframe 9 also transmits a responsive ACK/NAK signal in subframe 2 of the next frame. UL subframe 2 receives DL grant signals from nine DL subframes.

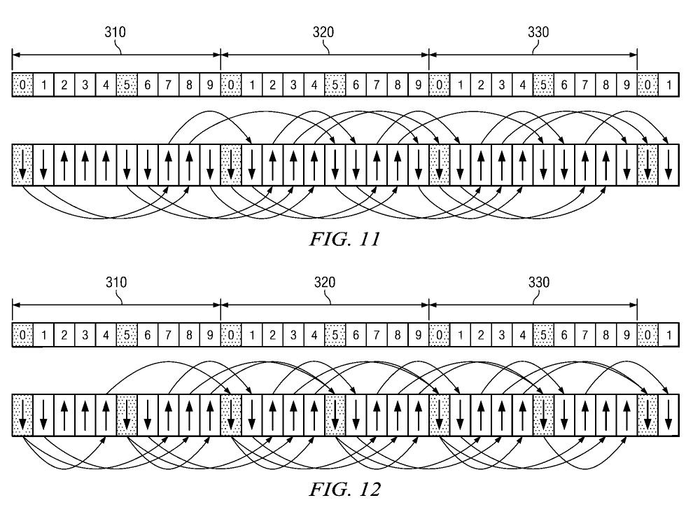

FIG. 11 illustrates the ACK/NAK response paths for a DL/UL subframe configuration 6 where subframes 0, 1, 5, 6 and 9 are devoted to DL and subframes 2, 3, 4, 7 and 8 are devoted to UL. A UE 109 receiving a DL grant in subframe 0 transmits a responsive ACK/NAK signal in subframe 7. A UE 109 receiving a DL grant in subframe 1 transmits a responsive ACK/NAK signal in subframe 8. A UE 109 receiving a DL grant in subframe 5 also transmits a responsive ACK/NAK signal in subframe 2 of the next frame. A UE 109 receiving a DL grant on subframe 6 transmits a responsive ACK/NAK signal on subframe 3 of the next frame. A UE 109 receiving a DL grant in subframe 9 transmits a responsive ACK/NAK signal in subframe 4 of the next frame. Each of UL subframes 2, 3, 4, 7 and 8 receive DL grant signals from a single DL subframe.

These response patterns are summarized in Table 2. Table 2 shows the DL subframes containing DL grants, as well as UL subframes containing ACK/NAK to support DL HARQ. The first column of Table 2 lists the configuration as noted above. The second column of Table 2 indicates the UL subframe used for the required ACK/NAK for each DL subframe. The third column of Table 2 indicates the number of DL subframes associated with each UL subframe.

TABLE 2

| DL/UL | DL Subframe Containing DL | UL Subframe |
|---|---|---|
| Config | Grant and DL Data | Containing ACK/NAK |
| 0 | 0-4 1-7 5-9 6-2 | 2(1) 4(1) 7(1) 9(1) |
| 1 | 0-7 1-7 4-8 5-2 | 2(2) 3(1) 7(2) 8(1) |
| | 6-2 9-3 | |
| 2 | 0-7 1-7 3-7 4-2 | 2(4) 7(4) |
| | 5-2 6-2 8-2 9-7 | |
| 3 | 0-4 1-2 5-2 6-2 | 2(3) 3(2) 4(2) |
| | 7-3 8-3 9-4 | |
| 3, Alt1 | 0-4 1-2 5-2 6-2 | 2(5) 3(1) 4(1) |
| | 7-2 8-2 9-3 | |
| 3, Alt2 | 0-4 1-2 5-2 6-2 | 2(4) 3(2) 4(1) |
| | 7-2 8-3 9-3 | |
| 4 | 0-2 1-2 4-2 5-2 | 2(4) 3(4) |
| | 6-3 7-3 8-3 9-3 | |
| 5 | 0-2 1-2 3-2 4-2 5-2 | 2(9) |
| | 6-2 7-2 8-2 9-2 | |
| 6 | 0-7 1-8 5-2 6-3 9-4 | 2(1) 3(1) 4(1) 7(1) 8(1) |

The 3GPP TS 36.211 standard requires in time division duplex (TDD) uplink (UL) that a UE 109 receiving a DL grant or ACK/NAK on physical hybrid repeat request channel (PHICH) in subframe n needs to transmit or retransmit UL data bits in an uplink (UL) subframe n+k, where k>3. FIGS. 12 to 19 illustrate the relation between DL/UL subframes associations for various combinations of assignments of DL/UL to particular subframes. Each of theses relations illustrated in FIGS. 12 to 19 are compliant with the requirement of the standard. FIGS. 12 to 19 illustrate frames 310, 320 and 330. Each frame 310, 320 and 330 has subframes 0 to 9. Subframes 0 and 5 are shaded to aid in determining the subframe alignment in the drawings.

FIG. 12 illustrates the UL data response paths for a DL/UL subframe configuration 0 where subframes 0, 1, 5 and 6 are devoted to DL and subframes 2, 3, 4, 7, 8 and 9 are devoted to UL. A UE 109 receiving a DL grant or an ACK/NAK on PHICH in subframe 0 transmits UL data in subframes 4 or 7. A UE 109 receiving a DL grant or an ACK/NAK on PHICH in subframe 1 transmits UL data in subframe 8. A UE 109 receiving a DL grant or an ACK/NAK on PHICH in subframe 5 transmits UL data in subframe 9 or subframe 2 of the next frame. A UE 109 receiving a DL grant or an ACK/NAK on PHICH in subframe 6 transmits UL data in subframe 3 of the next frame. A responding UE 109 transmits UL data in subframes 2, 3, 4, 7, 8 or 9.

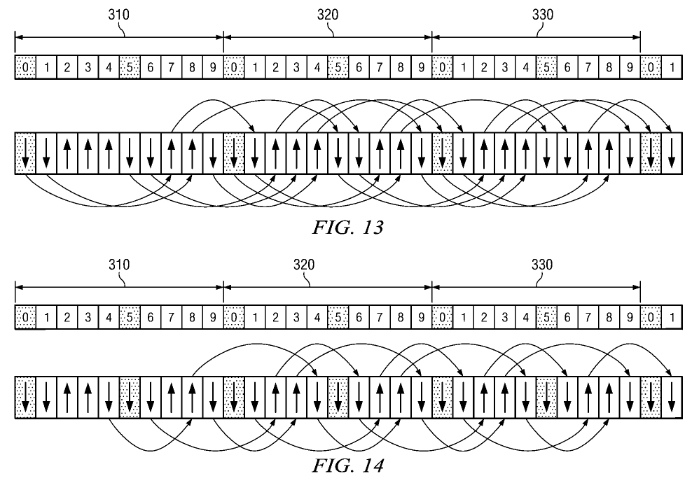

FIG. 13 illustrates an alternative for the UL DATA response paths for DL/UL subframe configuration 0 where subframes 0, 1, 5 and 6 are devoted to DL and subframes 2, 3, 4, 7, 8 and 9 are devoted to UL. A UE 109 receiving a DL grant or an ACK/NAK on PHICH in subframe 0 transmits UL data in subframe 4. A UE 109 receiving a DL grant or an ACK/NAK on PHICH in subframe 1 transmits UL data in subframes 7 or 8. A UE 109 receiving a DL grant or an ACK/NAK on PHICH in subframe 5 transmits UL data in subframe 9 or subframe 2 of the next frame. A UE 109 receiving a DL grant or an ACK/NAK on PHICH in subframe 6 transmits UL data in subframes 2 or 3 of the next frame. A responding UE 109 transmits UL data in subframes 2, 3, 4, 7, 8 or 9.

FIG. 14 illustrates the UL DATA response paths for a DL/UL subframe configuration 1 where subframes 1, 4, 5, 6 and 9 are devoted to DL and subframes 2, 3, 7 and 8 are devoted to UL. Note that subframes 0 and 6 nominally noted as a DL subframe cannot be used for DL grant or an ACK/NAK on PHICH. A UE 109 receiving a DL grant or an ACK/NAK on PHICH in subframe 1 transmits UL data in subframe 7. A UE 109 receiving a DL grant or an ACK/NAK on PHICH in subframe 4 transmits UL data in subframe 8. A UE 109 receiving a DL grant or an ACK/NAK on PHICH in subframe 6 also transmits a responsive ACK/NAK signal in subframe 2 of the next frame. A UE 109 receiving a DL grant or an ACK/NAK on PHICH in subframe 9 transmits UL data in subframe 3 of the next frame. A responding UE 109 transmits UL data in subframes

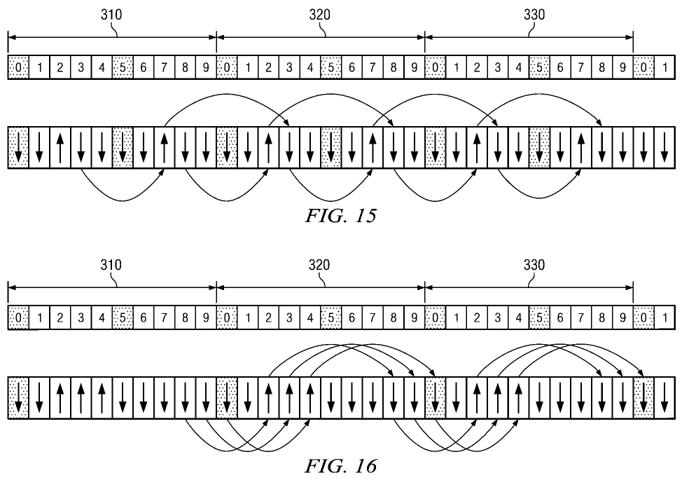

FIG. 15 illustrates the UL DATA response paths for a DL/UL subframe configuration 2 where subframes 3 and 8 are devoted to DL and subframes 2 and 7 are devoted to UL. Note that subframes 0, 1, 4, 5, 6 and 9 nominally noted as a DL subframes cannot be used for DL grant or an ACK/NAK on PHICH. A UE 109 receiving a DL grant or an ACK/NAK on PHICH in subframe 3 also transmits UL data in subframe 7. A UE 109 receiving a DL grant or an ACK/NAK on PHICH in subframe 8 transmits UL data in subframe 2 of the next frame. A responding UE 109 transmits UL data in subframes 2 and 7.

FIG. 16 illustrates the UL DATA response paths for a DL/UL subframe configuration 3 where subframes 0, 8 and 9 are devoted to DL and subframes 2, 3 and 4 are devoted to UL. Note that subframes 1, 5, 6, 7 nominally noted as DL subframes cannot be used for DL grant or an ACK>NAK on PHICH. A UE 109 receiving a DL grant or an ACK/NAK on PHICH in subframe 0 transmits UL data in subframe 4. A UE 109 receiving a DL grant or an ACK/NAK on PHICH in subframe 8 transmits UL data in subframe 2 of the next frame. A UE 109 receiving a DL grant or an ACK/NAK on PHICH in subframe 9 transmits UL data in subframe 3 of the next frame. A responding UE 109 transmits UL data in subframes 2, 3 and 4.

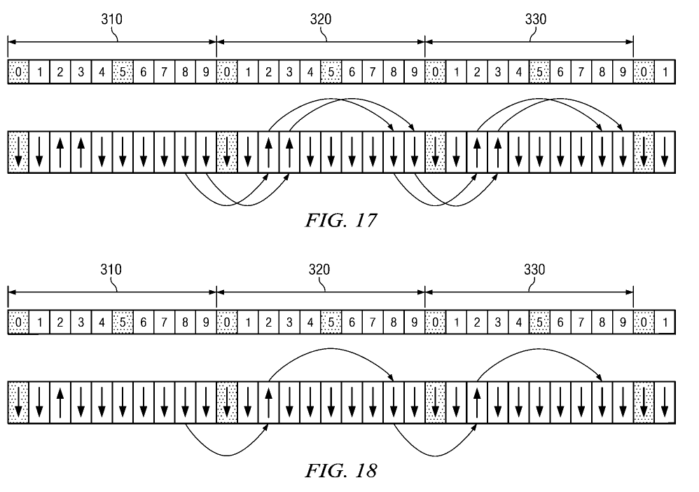

FIG. 17 illustrates the UL DATA response paths for a DL/UL subframe configuration 4 where subframes 8 and 9 are devoted to DL and subframes 2 and 3 are devoted to UL. Note that subframes 0, 1, 4, 5, 6 and 7 nominally DL subframes cannot be used for DL grant or an ACK/NAK on PHICH. A UE 109 receiving a DL grant or an ACK/NAK on PHICH in subframe 8 transmits UL data in subframe 2 of the next frame. A UE 109 receiving a DL grant or an ACK/NAK on PHICH in subframe 9 transmits UL data in subframe 3 of the next frame. A responding UE 109 transmits UL data in subframes 2 and 3.

FIG. 18 illustrates the UL DATA response paths for a DL/UL subframe configuration 5 where subframe 8 is devoted to DL and subframe 2 is devoted to UL. Note that subframes 0, 1, 3, 4, 5, 6, 7 and 9 nominally noted as DL subframes cannot be used to transmit a DL grant or and ACK/NAK on PHICH. A UE 109 receiving a DL grant or an ACK/NAK on PHICH in subframe 8 transmits UL data in subframe 2 of the next frame. A responding UE 109 transmits UL data in subframe 2.

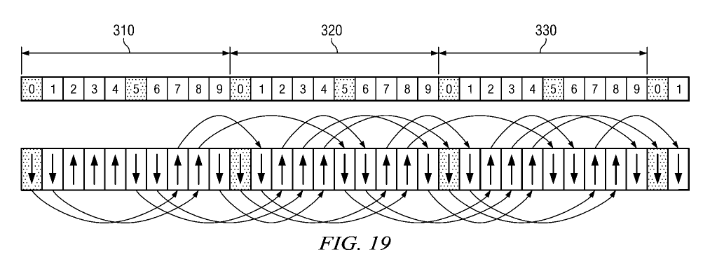

FIG. 19 illustrates the UL DATA response paths for a DL/UL subframe configuration 6 where subframes 0, 1, 5, 6 and 9 are devoted to DL and subframes 2, 3, 4, 7 and 8 are devoted to UL. A UE 109 receiving a DL grant or an ACK/NAK on PHICH in subframe 0 transmits UL data in subframe 7. A UE 109 receiving a DL grant or an ACK/NAK on PHICH in subframe 1 transmits UL data in subframe 8. A UE 109 receiving a DL grant or an ACK/NAK on PHICH in subframe 5 also transmits UL data in subframe 2 of the next frame. A UE 109 receiving a DL grant or an ACK/NAK on PHICH on subframe 6 transmits UL data on subframe 3 of the next frame. A UE 109 receiving a DL grant or an ACK/NAK on PHICH in subframe 9 transmits UL data in subframe 4 of the next frame. A responding UE 109 transmits UL data in subframes 2, 3, 4, 7 and 8.

These response patterns are summarized in Table 2. Table 3 shows the DL subframes containing DL grants or ACK/NAKs on PHICH. The first column of Table 3 lists the configuration as noted above. The second column of Table 3 indicates the UL subframe used for the required UL data for each DL subframe. The third column of Table 3 indicates the number of subframes used for the UL data response.

TABLE 3

| DL/UL | DL Subframe Containing UL | UL Subframe |
|---|---|---|
| Config | Grant or ACK/NAK (PHICH) | Containing Data |
| 0 | 0(4, 7) 1(8) 5(9, 2) 6(3) | 2 3 4 7 8 9 |
| 0 Alt | 0(4) 1(7, 8) 5(9) 6(2, 3) | 2 3 4 7 8 9 |
| 1 | 1(7) 4(8) 6(2) 9(3) | 2 3 7 8 |
| 2 | 3(7) 8(2) | 2 7 |
| 3 | 0(4) 8(2) 9(3) | 2 3 4 |
| 4 | 8(2) 9(3) | 2 3 |
| 5 | 8(2) | 2 |
| 6 | 0(7) 1(8) 5(2) 6(3) 9(4) | 2 3 4 7 8 |

What is claimed is:

1. A method of responding to a downlink grant in a wireless user equipment in a time division duplex system using frames including subframes 0 to 9 comprising the steps of:
assigning subframes 0, 1, 5 and 6 to downlink communication;
assigning subframes 2, 3, 4, 7, 8 and 9 to uplink communication;
upon receiving a downlink grant in subframe 0, the user equipment transmitting a responsive ACK/NAK signal in subframe 4;
upon receiving a downlink grant in subframe 1, the user equipment transmitting a responsive ACK/NAK signal in subframe 7;
upon receiving a downlink grant in subframe 5, the user equipment transmitting a responsive ACK/NAK signal in subframe 9; and
upon receiving a downlink grant in subframe 6, the user equipment transmitting a responsive ACK/NAK signal in subframe 1 of the next frame.

2. A method of responding to a downlink grant in a wireless user equipment in a time division duplex system using frames including subframes 0 to 9 comprising the steps of:
assigning subframes 0, 1, 4, 5, 6 and 9 to downlink communication;
assigning subframes 2, 3, 7 and 8 to uplink communication;
upon receiving a downlink grant in subframe 0, the user equipment transmitting a responsive ACK/NAK signal in subframe 7;
upon receiving a downlink grant in subframe 1, the user equipment transmitting a responsive ACK/NAK signal in subframe 7;
upon receiving a downlink grant in subframe 4, the user equipment transmitting a responsive ACK/NAK signal in subframe 8;
upon receiving a downlink grant in subframe 5, the user equipment transmitting a responsive ACK/NAK signal in subframe 2 of the next frame;
upon receiving a downlink grant in subframe 6, the user equipment transmitting a responsive ACK/NAK signal in subframe 2 of the next frame.

3. A method of responding to a downlink grant in a wireless user equipment in a time division duplex system using frames including subframes 0 to 9 comprising the steps of:
assigning subframes 0, 1, 3, 4, 5, 6, 8 and 9 to downlink communication;
assigning subframes 2 and 7 to uplink communication;
upon receiving a downlink grant in subframe 0, the user equipment transmitting a responsive ACK/NAK signal in subframe 7;
upon receiving a downlink grant in subframe 1, the user equipment transmitting a responsive ACK/NAK signal in subframe 7;
upon receiving a downlink grant in subframe 3, the user equipment transmitting a responsive ACK/NAK signal in subframe 7;
upon receiving a downlink grant in subframe 4, the user equipment transmitting a responsive ACK/NAK signal in subframe 2 of the next frame;
upon receiving a downlink grant in subframe 5, the user equipment transmitting a responsive ACK/NAK signal in subframe 2 of the next frame;
upon receiving a downlink grant in subframe 6, the user equipment transmitting a responsive ACK/NAK signal in subframe 2 of the next frame;
upon receiving a downlink grant in subframe 8, the user equipment transmitting a responsive ACK/NAK signal in subframe 2 of the next frame;
upon receiving a downlink grant in subframe 9, the user equipment transmitting a responsive ACK/NAK signal in subframe 7 of the next frame.

4. A method of responding to a downlink grant in a wireless user equipment in a time division duplex system using frames including subframes 0 to 9 comprising the steps of:
assigning subframes 0, 1, 5, 6, 7, 8 and 9 to downlink communication;
assigning subframes 2, 3 and 4 to uplink communication;
upon receiving a downlink grant in subframe 0, the user equipment transmitting a responsive ACK/NAK signal in subframe 4;
upon receiving a downlink grant in subframe 1, the user equipment transmitting a responsive ACK/NAK signal in subframe 2 of the next frame;
upon receiving a downlink grant in subframe 5, the user equipment transmitting a responsive ACK/NAK signal in subframe 2 of the next frame;
upon receiving a downlink grant in subframe 6, the user equipment transmitting a responsive ACK/NAK signal in subframe 2 of the next frame;
upon receiving a downlink grant in subframe 7, the user equipment transmitting a responsive ACK/NAK signal in subframe 3 of the next frame;
upon receiving a downlink grant in subframe 8, the user equipment transmitting a responsive ACK/NAK signal in subframe 3 of the next frame;
upon receiving a downlink grant in subframe 9, the user equipment transmitting a responsive ACK/NAK signal in subframe 3 of the next frame.

5. A method of responding to a downlink grant in a wireless user equipment in a time division duplex system using frames including subframes 0 to 9 comprising the steps of:
assigning subframes 0, 1, 5, 6, 7, 8 and 9 to downlink communication;
assigning subframes 2, 3 and 4 to uplink communication;
upon receiving a downlink grant in subframe 0, the user equipment transmitting a responsive ACK/NAK signal in subframe 4;
upon receiving a downlink grant in subframe 1, the user equipment transmitting a responsive ACK/NAK signal in subframe 2 of the next frame;
upon receiving a downlink grant in subframe 5, the user equipment transmitting a responsive ACK/NAK signal in subframe 2 of the next frame;
upon receiving a downlink grant in subframe 6, the user equipment transmitting a responsive ACK/NAK signal in subframe 2 of the next frame;
upon receiving a downlink grant in subframe 7, the user equipment transmitting a responsive ACK/NAK signal in subframe 2 of the next frame;
upon receiving a downlink grant in subframe 8, the user equipment transmitting a responsive ACK/NAK signal in subframe 3 of the next frame.

6. A method of responding to a downlink grant in a wireless user equipment in a time division duplex system using frames including subframes 0 to 9 comprising the steps of:
assigning subframes 0, 1, 5, 6, 7, 8 and 9 to downlink communication;
assigning subframes 2, 3 and 4 to uplink communication;
upon receiving a downlink grant in subframe 0, the user equipment transmitting a responsive ACK/NAK signal in subframe 4;
upon receiving a downlink grant in subframe 1, the user equipment transmitting a responsive ACK/NAK signal in subframe 2 of the next frame;
upon receiving a downlink grant in subframe 5, the user equipment transmitting a responsive ACK/NAK signal in subframe 2 of the next frame;
upon receiving a downlink grant in subframe 6, the user equipment transmitting a responsive ACK/NAK signal in subframe 2 of the next frame;
upon receiving a downlink grant in subframe 7, the user equipment transmitting a responsive ACK/NAK signal in subframe 2 of the next frame;
upon receiving a downlink grant in subframe 8, the user equipment transmitting a responsive ACK/NAK signal in subframe 3 of the next frame;
upon receiving a downlink grant in subframe 9, the user equipment transmitting a responsive ACK/NAK signal in subframe 3 of the next frame.

7. A method of responding to a downlink grant in a wireless user equipment in a time division duplex system using frames including subframes 0 to 9 comprising the steps of:
assigning subframes 0, 1, 4, 5, 6, 7, 8 and 9 to downlink communication;
assigning subframes 2 and 3 to uplink communication;
upon receiving a downlink grant in subframe 0, the user equipment transmitting a responsive ACK/NAK signal in subframe 2 of the next frame;
upon receiving a downlink grant in subframe 1, the user equipment transmitting a responsive ACK/NAK signal in subframe 2 of the next frame;
upon receiving a downlink grant in subframe 4, the user equipment transmitting a responsive ACK/NAK signal in subframe 2 of the next frame;
upon receiving a downlink grant in subframe 5, the user equipment transmitting a responsive ACK/NAK signal in subframe 2 of the next frame;
upon receiving a downlink grant in subframe 6, the user equipment transmitting a responsive ACK/NAK signal on subframe 3 of the next frame;
upon receiving a downlink grant in subframe 7, the user equipment transmitting a responsive ACK/NAK signal in subframe 3 of the next frame;
upon receiving a downlink grant in subframe 8, the user equipment transmitting a responsive ACK/NAK signal in subframe 3 of the next frame;
upon receiving a downlink grant in subframe 9, the user equipment transmitting a responsive ACK/NAK signal in subframe 3 of the next frame.

8. A method of responding to a downlink grant in a wireless user equipment in a time division duplex system using frames including subframes 0 to 9 comprising the steps of:
assigning subframes 0, 1, 3, 4, 5, 6, 7, 8 and 9 to downlink communication;
assigning subframe 2 to uplink communication;
upon receiving a downlink grant in subframe 0, the user equipment transmitting a responsive ACK/NAK signal in subframe 2 of the next frame;
upon receiving a downlink grant in subframe 1, the user equipment transmitting a responsive ACK/NAK signal in subframe 2 of the next frame;
upon receiving a downlink grant in subframe 4, the user equipment transmitting a responsive ACK/NAK signal in subframe 2 of the next frame;
upon receiving a downlink grant in subframe 5, the user equipment transmitting a responsive ACK/NAK signal in subframe 2 of the next frame;
upon receiving a downlink grant in subframe 6, the user equipment transmitting a responsive ACK/NAK signal on subframe 2 of the next frame;
upon receiving a downlink grant in subframe 7, the user equipment transmitting a responsive ACK/NAK signal in subframe 2 of the next frame;
upon receiving a downlink grant in subframe 8, the user equipment transmitting a responsive ACK/NAK signal in subframe 2 of the next frame;
upon receiving a downlink grant in subframe 9, the user equipment transmitting a responsive ACK/NAK signal in subframe 2 of the next frame.

9. A method of responding to a downlink grant in a wireless user equipment in a time division duplex system using frames including subframes 0 to 9 comprising the steps of:
assigning subframes 0, 1, 5, 6 and 9 to downlink communication;
assigning subframes 2, 3, 4, 7 and 8 to uplink communication;
upon receiving a downlink grant in subframe 0, the user equipment transmitting a responsive ACK/NAK signal in subframe 7;
upon receiving a downlink grant in subframe 1, the user equipment transmitting a responsive ACK/NAK signal in subframe 8;
upon receiving a downlink grant in subframe 5, the user equipment transmitting a responsive ACK/NAK signal in subframe 2 of the next frame;
upon receiving a downlink grant in subframe 6, the user equipment transmitting a responsive ACK/NAK signal on subframe 3 of the next frame;
upon receiving a downlink grant in subframe 9, the user equipment transmitting a responsive ACK/NAK signal in subframe 4 of the next frame.

10. A method of responding to a downlink grant or an ACK/NAK on physical hybrid automatic repeat request channel (PHICH) in a wireless user equipment in a time division duplex system using frames including subframes 0 to 9 comprising the steps of:
assigning subframes 0, 1, 5 and 6 to downlink communication;
assigning subframes 2, 3, 4, 7, 8 and 9 to uplink communication;
upon receiving a downlink grant or an ACK/NAK on PHICH in subframe 0, a user equipment transmitting uplink data in subframes 4 or 7;
upon receiving a downlink grant or an ACK/NAK on PHICH in subframe 1, a user equipment transmitting uplink data in subframe 8;
upon receiving a downlink grant or an ACK/NAK on PHICH in subframe 5, a user equipment transmitting uplink data in subframe 9 or subframe 2 of the next frame;
upon receiving a downlink grant or an ACK/NAK on PHICH in subframe 6, a user equipment transmitting uplink data in subframe 3 of the next frame.

11. A method of responding to a downlink grant or an ACK/NAK on physical hybrid automatic repeat request channel (PHICH) in a wireless user equipment in a time division duplex system using frames including subframes 0 to 9 comprising the steps of:
assigning subframes 0, 1, 5 and 6 to downlink communication;
assigning subframes 2, 3, 4, 7, 8 and 9 to uplink communications
upon receiving a downlink grant or an ACK/NAK on PHICH in subframe 0, a user equipment transmitting uplink data in subframe 4;
upon receiving a downlink grant or an ACK/NAK on PHICH in subframe 1, a user equipment transmitting uplink data in subframes 7 or 8;
upon receiving a downlink grant or an ACK/NAK on PHICH in subframe 5, a user equipment transmitting data in subframe 9 or subframe 2 of the next frame;
upon receiving a downlink grant or an ACK/NAK on PHICH in subframe 6, a user equipment transmitting uplink data in subframes 2 or 3 of the next frame;
upon, a user equipment transmitting uplink data in subframes 2, 3, 4, 7, 8 or 9.

12. A method of responding to a downlink grant or an ACK/NAK on PHICH in a wireless user equipment in a time division duplex system using frames including subframes 0 to 9 comprising the steps of:
assigning subframes 1, 4, 5, 6 and 9 to downlink communication;
assigning subframes 2, 3, 7 and 8 to uplink communication;
upon receiving a downlink grant or an ACK/NAK on PHICH in subframe 1, a user equipment transmitting uplink data in subframe 7;
upon receiving a downlink grant or an ACK/NAK on PHICH in subframe 4, a user equipment transmitting uplink data in subframe 8;
upon receiving a downlink grant or an ACK/NAK on PHICH in subframe 6, a user equipment transmitting a responsive ACK/NAK signal in subframe 2 of the next frame;
upon receiving a downlink grant or an ACK/NAK on PHICH in subframe 9, a user equipment transmitting uplink data in subframe 3 of the next frame.

13. A method of responding to a downlink grant or an ACK/NAK on physical hybrid automatic repeat request channel (PHICH) in a wireless user equipment in a time division duplex system using frames including subframes 0 to 9 comprising the steps of:
assigning subframes 3 and 8 to downlink communication;
assigning subframes 2 and 7 to uplink communication;
upon receiving a downlink grant or an ACK/NAK on PHICH in subframe 3, a user equipment transmitting uplink data in subframe 7;
upon receiving a downlink grant or an ACK/NAK on PHICH in subframe 8, a user equipment transmitting uplink data in subframe 2 of the next frame.

14. A method of responding to a downlink grant or an ACK/NAK on physical hybrid automatic repeat request channel (PHICH) in a wireless user equipment in a time division duplex system using frames including subframes 0 to 9 comprising the steps of:
assigning subframes 0, 8 and 9 to downlink communication;
assigning subframes 2, 3 and 4 to uplink communication;
upon receiving a downlink grant or an ACK/NAK on PHICH in subframe 0, a user equipment transmitting uplink data in subframe 4;
upon receiving a downlink grant or an ACK/NAK on PHICH in subframe 8, a user equipment transmitting uplink data in subframe 2 of the next frame;
upon receiving a downlink grant or an ACK/NAK on PHICH in subframe 9, a user equipment transmitting uplink data in subframe 3 of the next frame.

15. A method of responding to a downlink grant or an ACK/NAK on physical hybrid automatic repeat request channel (PHICH) in a wireless user equipment in a time division duplex system using frames including subframes 0 to 9 comprising the steps of:
assigning subframes 8 and 9 to downlink communication;
assigning subframes 2 and 3 to uplink communication;
upon receiving a downlink grant or an ACK/NAK on PHICH in subframe 8, a user equipment transmitting uplink data in subframe 2 of the next frame;
upon receiving a downlink grant or an ACK/NAK on PHICH in subframe 9, a user equipment transmitting uplink data in subframe 3 of the next frame.

16. A method of responding to a downlink grant or an ACK/NAK on physical hybrid automatic repeat request channel (PHICH) in a wireless user equipment in a time division duplex system using frames including subframes 0 to 9 comprising the steps of:
assigning subframe 8 to downlink communication;
assigning subframe 2 to uplink communication;
upon receiving a downlink grant or an ACK/NAK on PHICH in subframe 8, a user equipment transmitting uplink data in subframe 2 of the next frame.

17. A method of responding to a downlink grant or an ACK/NAK on physical hybrid automatic repeat request channel (PHICH) in a wireless user equipment in a time division duplex system using frames including subframes 0 to 9 comprising the steps of:
assigning subframes 0, 1, 5, 6 and 9 to downlink communication;
assigning subframes 2, 3, 4, 7 and 8 to uplink communication;
upon receiving a downlink grant or an ACK/NAK on PHICH in subframe 0, a user equipment transmitting uplink data in subframe 7;
upon receiving a downlink grant or an ACK/NAK on PHICH in subframe 1, a user equipment transmitting uplink data in subframe 8;
upon receiving a downlink grant or an ACK/NAK on PHICH in subframe 5, a user equipment transmitting uplink data in subframe 2 of the next frame;
upon receiving a downlink grant or an ACK/NAK on PHICH on subframe 6, a user equipment transmitting uplink data on subframe 3 of the next frame;
upon receiving a downlink grant or an ACK/NAK on PHICH in subframe 9, a user equipment transmitting uplink data in subframe 4 of the next frame.
